(19) United States
(12) Patent Application Publication
(10) Pub. No.: US 2005/0062688 A1
(43) Pub. Date: Mar. 24, 2005

(54) Apparatus and method for driving a plasma display panel

(75) Inventors: Jeung Hwan Lee, Daegu (KR); Moon Shick Chung, Gumi-si (KR); Chang Hwan Koo, Daegu (KR); Jung Sub Shin, Gangwon-do (KR)

Correspondence Address: FLESHNER & KIM, LLP, P.O. BOX 221200, CHANTILLY, VA, 20153, US

(73) Assignee: LG Electronics Inc.

(21) Appl. No.: 10/942,802

(22) Filed: Sep. 17, 2004

(30) Foreign Application Priority Data
Sep. 18, 2003 (KR) 10-2003-0064810

(51) Int. Cl. G09G 3/28

(52) U.S. Cl. 345/60

(57) ABSTRACT

The present invention relates to an apparatus for driving a plasma display panel and method thereof, and more particularly, to an apparatus for driving a plasma display panel and method thereof in which a width of a scan pulse varies depending on whether data exist or not, thus improving the image quality. According to an embodiment of the present invention, the apparatus includes a plasma display panel for displaying video data, a data detection part for detecting whether video data received from an input line exists or not, an APL calculation part for generating an APL signal corresponding to a stage of the number of a sustain pulse supplied to the plasma display panel depending on whether the video data from the data detection part exists or not, and a timing controller for varying a width of a scan pulse supplied to the plasma display panel depending on whether the video data from the data detection part exists or not and also varying the number of the sustain pulse supplied to the plasma display panel in response to the APL signal. According to the present invention, it is possible to improve brightness by increasing the number of a sustain pulse of a sustain period in a region where normal video data is supplied.

This Nonprovisional application claims priority under 35 U.S.C. § 119(a) on Patent Application No. 10-2003-0064810 filed in Korea on Sep. 18, 2003, the entire contents of which are hereby incorporated by reference.

### BACKGROUND OF THE INVENTION

1. Field of the Invention

The present invention relates to an apparatus for driving a plasma display panel and method thereof, and more particularly, to an apparatus for driving a plasma display panel and method thereof in which a width of a scan pulse varies depending on whether data exist or not, thus improving the image quality.

2. Description of the Background Art

A plasma display panel (hereinafter, referred to as a ‘PDP’) is adapted to display an image including characters or graphics by light-emitting phosphors with ultraviolet of 147 nm generated during the discharge of an inert mixed gas such as He+Xe, Ne+Xe or He+Ne+Xe, or the like. This PDP can be easily made thin and large, and it can provide greatly increased image quality with the recent development of the relevant technology. Particularly, a three-electrode AC surface discharge type PDP has advantages of lower driving voltage and longer product lifespan as a wall charge is accumulated on a surface in discharging and electrodes are protected from sputtering caused by discharging.

Referring now to FIG. 1, a discharge cell of a three-electrode AC surface discharge type PDP includes a scan electrode Y and a sustain electrode Z which are formed on the bottom surface of an upper substrate 10, and an address electrode X formed on a lower substrate 18. Each of the scan electrode Y and the sustain electrode Z includes transparent electrodes 12Y and 12Z, and metal bus electrodes 13Y and 13Z which have a line width smaller than that of the transparent electrodes 12Y and 12Z and are respectively disposed at one side edges of the transparent electrodes.

The transparent electrodes 12Y and 12Z, which are typically made of ITO (indium tin oxide), are formed on the bottom surface of the upper substrate 10. The metal bus electrodes 13Y and 13Z are formed on the transparent electrodes 12Y and 12Z typically made of a metal such as chromium (Cr), and serves to reduce a voltage drop caused by the transparent electrodes 12Y and 12Z having high resistance. On the bottom surface of the upper substrate 10 in which the scan electrode Y and the sustain electrode Z are placed parallel to each other is laminated an upper dielectric layer 14 and a protective layer 16. The upper dielectric layer 14 is accumulated with a wall charge generated during plasma discharging. The protective layer 16 is adapted to prevent damages of the upper dielectric layer 14 due to sputtering caused during plasma discharging, and improve efficiency of secondary electron emission. As the protective layer 16, magnesium oxide (MgO) is typically used.

A lower dielectric layer 22 and barrier ribs 24 are formed on the lower substrate 18 in which the address electrode X is formed. A phosphor layer 26 is applied to the surfaces of both the lower dielectric layer 22 and the barrier rib 24. The address electrode X is formed on the lower substrate 18 in the direction in which the address electrode X intersect the scan electrode Y and the sustain electrode Z. The barrier rib 24 is formed in the form of stripe or lattice to prevent leakage of an ultraviolet and a visible light generated by discharging to adjacent discharge cells. The phosphor layer 26 is excited with an ultraviolet generated during the plasma discharging to generate any one visible light of red, green and blue lights. An inert mixed gas is injected into the discharge spaces defined between the upper substrate 10 and the barrier ribs 24 and between the lower substrate 18 and the barrier ribs 24.

In this PDP, in order to implement the gray level of an image, one frame is divided into several sub fields having different numbers of emission and is then driven in time division. Each of the sub fields is divided into an initialization period for initializing the whole screen, an address period for selecting a scan line and selecting a cell from the selected scan line, and a sustain period for implementing the gray level depending on the number of discharging.

In the above, the initialization period is divided into a set-up period where a rising ramp waveform is supplied and a set-down period where a falling ramp waveform is supplied. For example, if a picture is to be represented using 256 gray levels, a frame period (16.67 ms) corresponding to 1/60 second is divided into eight sub fields SF1 to SF8, as shown in FIG. 2. Also, as described above, each of the 8 sub fields SF1 to SF8 is divided into an initialization period, an address period and a sustain period. In the above, the initialization period and the address period of each of the sub fields are the same every sub fields, whereas the sustain period of each of the sub fields increases in the ratio of 2n (n=0,1,2,3,4,5,6,7) in each of the sub fields.

Referring to FIG. 3, a PDP is driven with it divided into an initialization period for initializing the whole screen, an address period for selecting a cell, and a sustain period for maintaining discharging of the selected cell.

In the initialization period, a rising ramp waveform Ramp-up is applied to all the scan electrodes Y in a set-up period at the same time. Weak discharging occurs within the cells of the whole screen by means of the rising ramp waveform Ramp-up, so that a wall charge is generated within the cells. In a set-down period, after a rising ramp waveform Ramp-up is supplied, a falling ramp waveform Ramp-down that is lower than the peak voltage of the rising ramp waveform Ramp-up and falls from a voltage of the positive polarity is applied to the scan electrodes Y at the same time. The falling ramp waveform Ramp-down causes weak erase discharging to occur within the cells. Thus, unnecessary charges of wall charges and space charges generated by the set-up discharging are erased and wall charges necessary for the address discharging are kept remain within the cells of the whole screen.

In the address period, simultaneously when a scan pulse Scan of the negative polarity is sequentially applied to the scan electrodes Y, a data pulse data of the positive polarity is applied to the address electrodes X. While a potential difference between the scan pulse Scan and the data pulse data and a wall voltage generated by the initialization period are added, an address discharge occurs within a cell to which the data pulse data is applied. A wall charge is generated within cells selected by the address discharging.

Meanwhile, during the set-down period and the address period, a DC voltage of the positive polarity of the sustain voltage level Vs is applied to the sustain electrodes Z.

In the sustain period, a sustain pulse sus is alternately applied to the scan electrodes Y and the sustain electrodes Z. Then, in the cell selected by the address discharging, the sustain discharging occurs in the form of surface discharging between the scan electrode Y and the sustain electrode Z whenever each sustain pulse sus is applied while the wall voltage and the sustain pulse sus within the cell are added. Finally, after the sustain discharge is completed, an erase ramp waveform erase having a low pulse width is supplied to the sustain electrodes Z, erasing the wall charge within the cell.

Referring to FIG. 4, the conventional apparatus for driving the PDP includes a first inverse gamma correction part 32A, a gain control part 34, an error diffusion part 36, a sub field mapping part 38 and a data alignment part 40 all of which are connected between an input line 1 and a plasma display panel 46; a second inverse gamma correction part 32B and an average picture level (hereinafter, referred to as APL) calculation part 42 connected between the input line 1 and the plasma display panel 46; and a timing controller 44 connected between the APL calculation part 42 and the plasma display panel 46.

The first and second inverse gamma correction parts 32A and 32B perform inverse gamma correction for a gamma-corrected video signal to linearly convert a brightness value depending on a gray level value of a picture signal.

The APL calculation part 42 generates using an N (N is a natural number) stage signal for controlling the number of a sustain pulse using the video data corrected by the second inverse gamma correction part 32B. Meanwhile, the APL detected by the APL calculation part 42 is inputted to the timing controller 44.

The gain control part 34 amplifies the video data corrected in the first inverse gamma correction part 32 as much as an effective gain.

The error diffusion part 36 minutely controls the brightness value by diffusing an error component of a cell to adjacent cells. The sub field mapping part 38 reallocates the video data corrected from the error diffusion part 36 by the sub field.

The data alignment part 40 converts the video data received from the sub field mapping part 38 appropriately to a resolution format of the plasma display panel 46 and then supplies the converted video data to an address driving integrated circuit (hereinafter, referred to as IC) of the plasma display panel 46.

The timing controller 44 generates a timing control signal according to the N stage signal received from the APL calculation part 42, as shown in FIG. 5, and controls a circuit that generates a sustain pulse according to the APL to adjust the number of a sustain pulse. Further, the timing controller 44 supplies the generated timing control signal to an address driving IC, a scan driving IC and a sustain driving IC of the plasma display panel 46.

An address driving IC (not shown) generates scan pulses Scan that are sequentially shifted according to a clock signal CLK in response to the timing control signal-received from the timing controller 44, as shown in FIG. 6, and supplies the generated scan pulses to the scan lines S1 to Sn of the plasma display panel 46. At this time, the clock signal CLK has the same period T1 in a 1 horizontal period 1H unit. Due to this, the scan pulses Scan that are sequentially outputted have the same width. Accordingly, the conventional PDP scans in batch regardless of whether video data exist or not, the same operation is performed even in any picture.

In the concrete, as shown in FIG. 7, if a signal-void video data 50 or a very dark video data is displayed at upper and lower edge regions on the plasma display panel 46 of the PDP and a signal-present video data 52 is displayed in a region between the upper and lower edges, a width of the scan pulse Scan supplied to each of the scan lines S1 to Sn in a region where the signal-void video data 50 is supplied on the plasma display panel 46 and a width of the scan pulse Scan supplied to each of the scan lines S1 to Sn in a region where the signal-present video data 52 is supplied become the same in the conventional PDP. Resultantly, since the width of the scan pulse Scan supplied to each of the scan lines S1 to Sn of the plasma display panel 46 is the same, it is required that brightness be improved using a method such as modification of the number of a sustain pulse or a video data.

### SUMMARY OF THE INVENTION

Accordingly, an object of the present invention is to solve at least the problems and disadvantages of the background art.

The present invention has been made in view of the above problems, and it is an object of the present invention to provide an apparatus for driving a plasma display plasma display panel and method thereof in which a width of a scan pulse varies depending on whether data exist or not, thus improving the image quality.

To achieve the above object, according to a first embodiment of the present invention, there is provided an apparatus for driving a plasma display panel, including: a plasma display panel for displaying video data, a data detection part for detecting whether video data received from an input line exists or not, an APL calculation part for generating an APL signal corresponding to a stage of the number of a sustain pulse supplied to the plasma display panel depending on whether the video data from the data detection part exists or not, and a timing controller for varying a width of a scan pulse supplied to the plasma display panel depending on whether the video data from the data detection part exists or not and also varying the number of the sustain pulse supplied to the plasma display panel in response to the APL signal.

To achieve the above object, according to a second embodiment of the present invention, there is provided a method for driving a plasma display panel on which video data is displayed, including: a first step of detecting whether the video data received from an input line exists or not, a second step of generating an APL signal corresponding to a stage of the number of a sustain pulse supplied to the plasma display panel depending on whether the video data exists or not, and a third step of varying a width of a scan pulse supplied to the plasma display panel depending on whether the video data exists or not and also varying the number of the sustain pulse supplied to the plasma display panel in response to the APL signal.

According to the present invention, it is possible to improve brightness by increasing the number of a sustain pulse of a sustain period in a region where normal video data is supplied.

### BRIEF DESCRIPTION OF THE DRAWINGS

The invention will be described in detail with reference to the following drawings in which like numerals refer to like elements.

FIG. 1 is a perspective view illustrating the structure of a discharge cell of a conventional three-electrode AC surface discharge type plasma display panel;

FIG. 2 shows one frame of a typical plasma display panel;

FIG. 3 is a waveform illustrating a driving waveform supplied to electrodes of a conventional plasma display panel;

FIG. 4 is a block diagram showing the structure of a conventional apparatus for driving a plasma display panel;

FIG. 5 shows the relationship between an APL and the number of a sustain pulse;

FIG. 6 shows a waveform of a scan pulse supplied to the plasma display panel shown in FIG. 4;

FIG. 7 illustrates video data supplied to the plasma display panel shown in FIG. 4;

FIG. 8 is a block diagram showing an apparatus for driving a plasma display panel according to an embodiment of the present invention;

FIG. 9 is a graph showing the relationship between the number of a sustain pulse and the step of an APL depending on whether video data exists or not;

FIG. 10 shows a waveform of a scan pulse that varies depending on whether video data exists or not and is supplied to the plasma display panel;

FIG. 11 illustrates video data supplied to the plasma display panel shown in FIG. 8;

FIG. 12 shows a waveform of a scan pulse having a T1 period that is supplied to the plasma display panel shown in FIG. 10 in case of signal-void video data; and

FIG. 13 shows a waveform of a scan pulse having a T2 period that is supplied to the plasma display panel shown in FIG. 10 in case of signal-present video data.

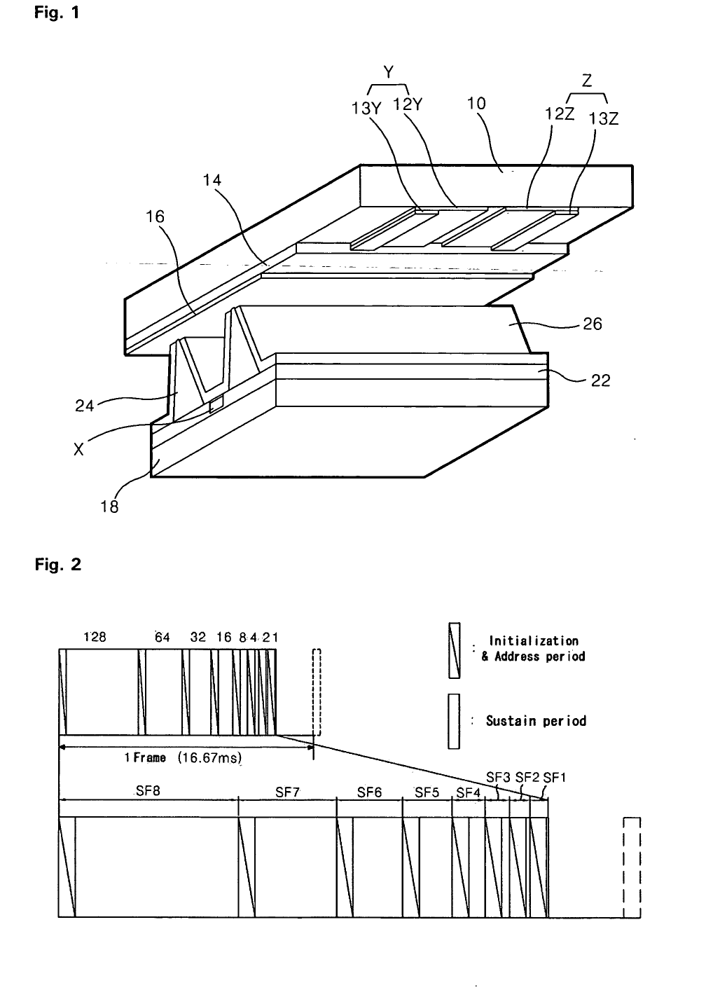

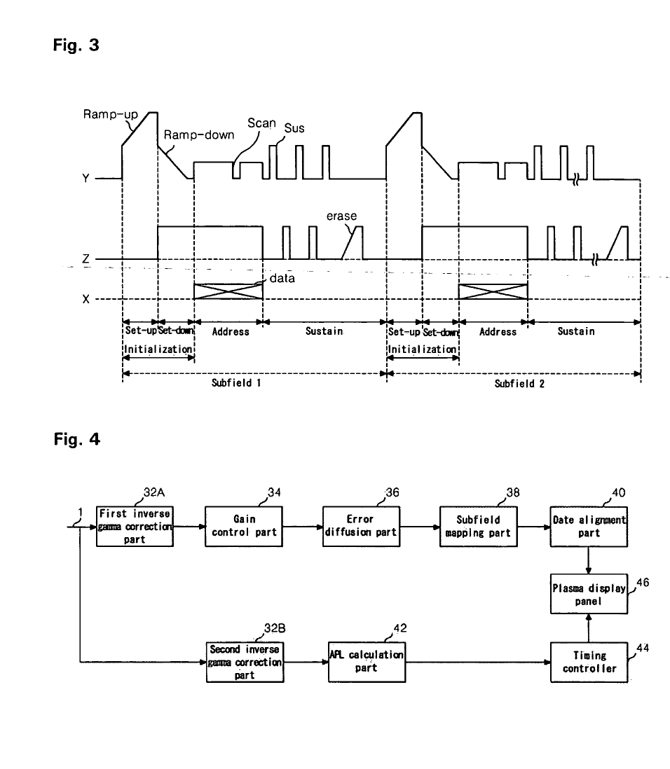

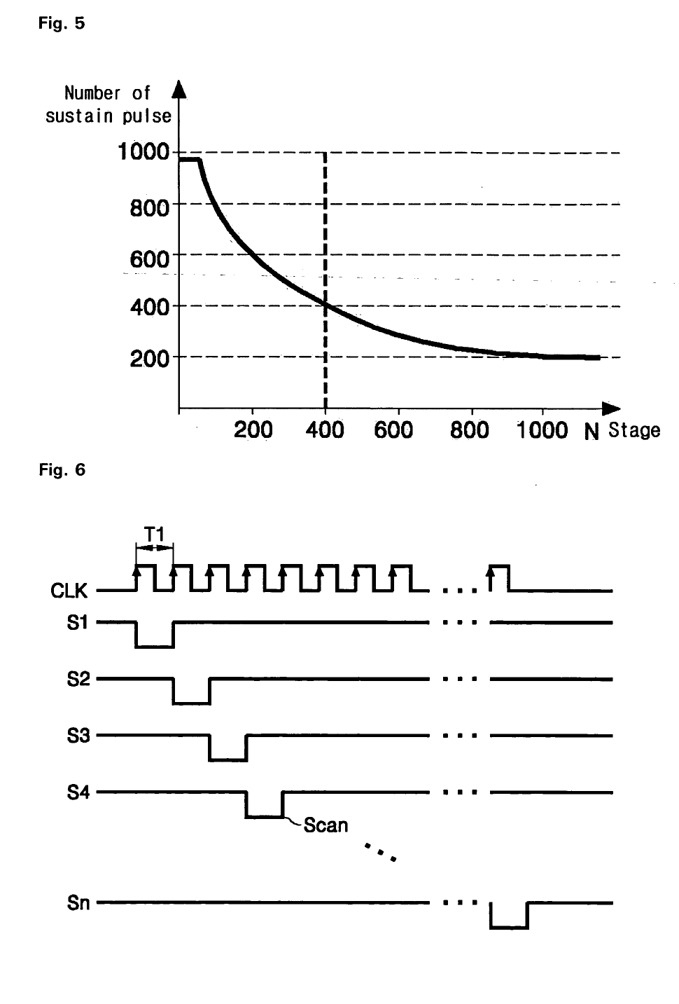

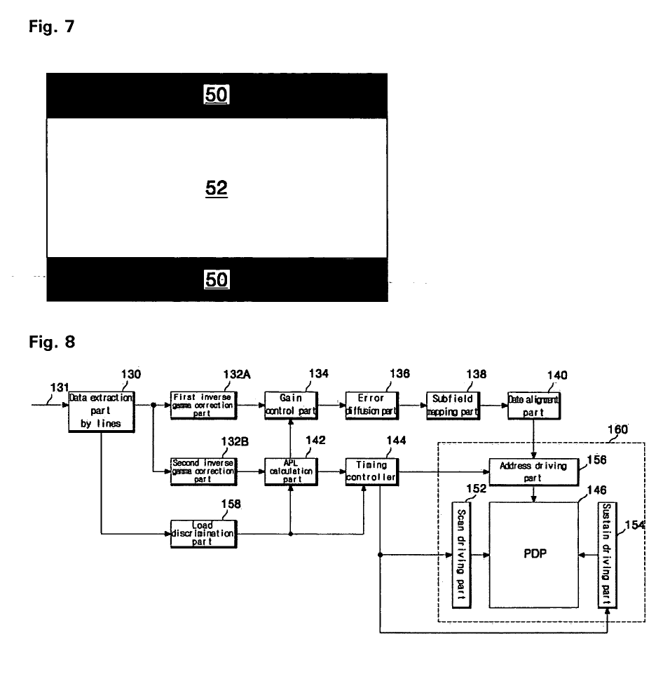

### DETAILED DESCRIPTION OF PREFERRED EMBODIMENTS

Preferred embodiments of the present invention will be described in a more detailed manner with reference to the drawings.

<First Embodiment>

According to a first embodiment of the present invention, there is provided an apparatus for driving a plasma display panel, including: a plasma display panel for displaying video data, a data detection part for detecting whether video data received from an input line exists or not, an APL calculation part for generating an APL signal corresponding to a stage of the number of a sustain pulse supplied to the plasma display panel depending on whether the video data from the data detection part exists or not, and a timing controller for varying a width of a scan pulse supplied to the plasma display panel depending on whether the video data from the data detection part exists or not and also varying the number of the sustain pulse supplied to the plasma display panel in response to the APL signal.

In the apparatus, the data detection part includes a data extraction part for extracting the video data received from the input line in the 1 horizontal period unit, and a load discrimination part for determining whether the video data received in the 1 horizontal period unit from the data extraction part exists or not to generate a discrimination signal.

In the apparatus, the timing controller varies the period of a reference clock signal for generating the scan pulse in response to the discrimination signal from the load discrimination part.

The apparatus further includes a scan driving part that uses the reference clock signal to generate the scan pulse that is sequentially shifted and supplies the scan pulse to the plasma display panel, and a sustain driving part that supplies the sustain pulse to the plasma display panel in response to a control signal from the timing controller.

In the apparatus, the load discrimination part generates a discrimination signal by determining to which the video data received from the data extraction part corresponds signal-void video data including pure signal-void video data, video data corresponding to a very dark gray level and video data having a gray level that cannot be seen by a user s naked eyes, or signal-present video data including normal video data.

In the apparatus, the timing controller reduces the period of the reference clock signal for reducing the period of the scan pulse according to the discrimination signal corresponding to the signal-void video data from the load discrimination part.

In the apparatus, the APL calculation part generates an APL signal in which the number of the sustain pulse is increased by reducing the stage of the number of the sustain pulse according to the discrimination signal corresponding to the signal-void video data from the load discrimination part.

In the apparatus, the timing controller increases the sustain time in each horizontal period where the signal-present video data is supplied according to the APL signal whose number of the sustain pulse from the APL calculation part is increased.

The first embodiment of the present invention will now be described in detail with reference to the accompanying drawings.

Referring to FIG. 8, an apparatus for driving a plasma display panel (hereinafter, referred to as PDP) according to a first embodiment of the present invention includes a data extraction part by lines 130, a first inverse gamma correction part 132A, a gain control part 134, an error diffusion part 136, a sub field mapping part 138 and a data alignment part 140 all of which are connected between an input line 131 and a plasma display panel 160; a timing controller 144 for controlling a plasma display panel 160; a second inverse gamma correction part 132B and an average picture level (hereinafter, referred to as APL) calculation part 142 both of which are connected between the data extraction part by lines 130 and the timing controller 144; and a load discrimination part 158 for determining whether data exists using data by the line received from the data extraction part by lines 130 and supplying a signal indicating whether detected data exists or not to the APL calculation part 142 and the timing controller 144.

The data extraction part by lines 130 serves to extract the video data received from the input line 131 in an 1 horizontal period unit and supplies the extracted video data to both the first and second inverse gamma correction parts 132A and 132B and the load discrimination part 158.

The first and second inverse gamma correction parts 132A and 132B perform inverse gamma correction for the gamma-corrected video data to linearly convert a brightness value depending on a gray level value of a picture signal.

The gain control part 134 functions to amplify the video data corrected in the first inverse gamma correction part 132A as much as an effective gain.

The error diffusion part 136 minutely controls a brightness value by diffusing error components of cells to adjacent cells. The sub field mapping part 138 reallocates the video data corrected from the error diffusion part 136 by sub fields.

The data alignment part 140 converts the video data received from the sub field mapping part 138 appropriately to a resolution format of the PDP 146 and supplies the converted video data to an address driving part 156 within the plasma display panel 160.

The load discrimination part 158 serves to determine whether the video data received from the data extraction part by lines 130 in a 1 horizontal period unit exists or not. The load discrimination part 158 counts a video data value by a line that is stored in a register using a counter disposed in the register for storing the video data by the line received from the data extraction part by lines 130. Further, the load discrimination part 158 functions to determine to which the video data received from the data extraction part by lines 130 corresponds a signal-present video data, a signal-void video data, a video data corresponding to a very dark gray level or a gray level that cannot be seen by a user s naked eyes based on the counted video data by the line to generate a discrimination signal and supplies the discrimination signal to the APL calculation part 142 and the timing controller 144.

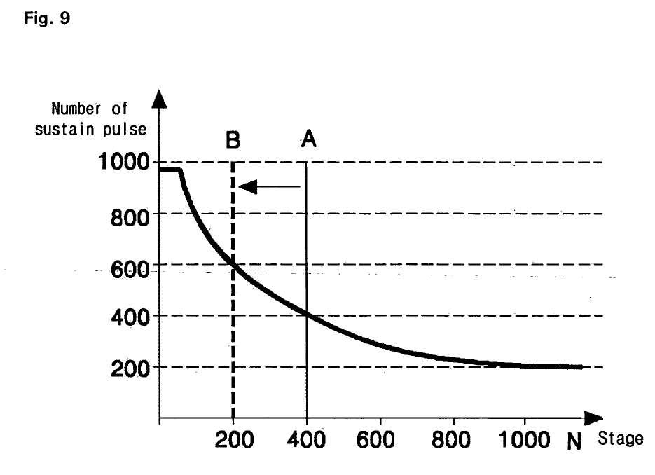

The APL calculation part 142 generates an APL N stage signal for controlling the number of a sustain pulse using the video data corrected by the second inverse gamma correction part 132B. At this time, the APL calculation part 142 increases the number of the sustain pulse by subtracting a value corresponding to the discrimination signal received from the load discrimination part 158 from the APL N stage signal, as shown in FIG. 9. For example, the APL calculation part 142 generates an APL stage signal corresponding to the number of a normal sustain pulse 400 in an APL stage (A) according to a discrimination signal corresponding to a signal-void video data and generates an APL stage signal substantially corresponding to the number of a sustain pulse 600 according to a discrimination signal corresponding to a signal-present video data as the APL B decreases to ‘200’ in case of a normal video data.

This APL calculation part 142 generates an APL stage signal according to the discrimination signal received from the load discrimination part 158 and inputs the generated APL stage signal to the timing controller 144.

The timing controller 144 is connected between the APL calculation part 142 and the plasma display panel 160 and supplies horizontal/vertical synchronization signals H and V and a timing control signal all of which are received from the outside to the scan driving part 152, the sustain driving part 154 and the address driving part 156. Further, the timing controller 144 controls a circuit for generating a sustain pulse according to the APL stage signal received from the APL calculation part 142 to adjust the number of a sustain pulse and also varies the period of the clock signal CLK for varying a pulse width of the scan pulse Scan that is supplied to the scan line of the PDP 146 based on the discrimination signal received from the load discrimination part 158.

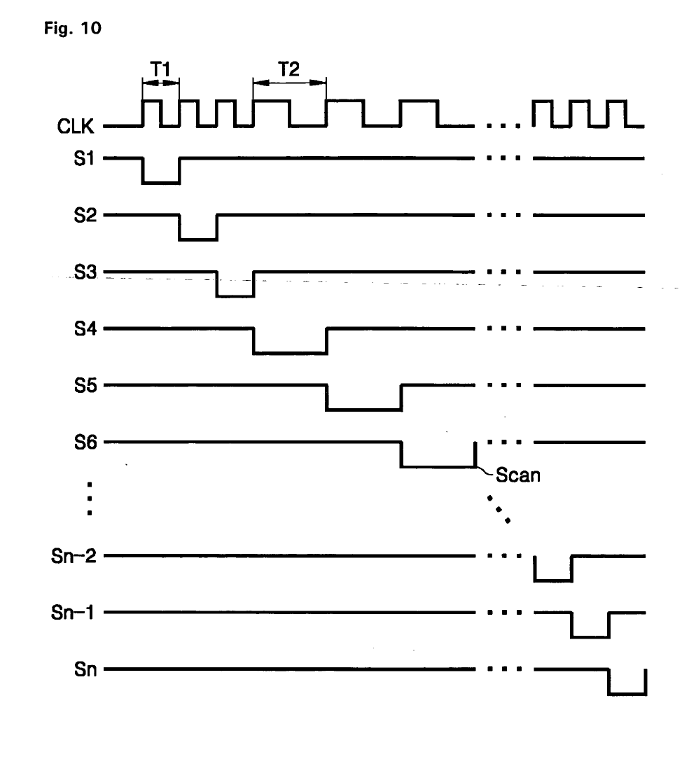

To this end, the timing controller 144 varies the periods T1 and T2 of the clock signal CLK for generating the scan pulse Scan using a counter (not shown) for counting a reference clock, as shown in FIG. 10.

In the concrete, the timing controller 144 generates a clock signal CLK having a period T1 shorter than a normal period if the discrimination signal received from the load discrimination part 158 is any one of a pure signal-void video data, a video data corresponding to a very dark gray level and a gray level that cannot be seen by a user s naked eyes, and supplies the generated clock signal CLK to the scan driving part 152. On the contrary, the timing controller 144 generates a clock signal CLK having a normal period T2 if the discrimination signal received from the load discrimination part 158 is a normal signal-present video data, and supplies the generated clock signal CLK to the scan driving part 152.

The plasma display panel part 160 includes a PDP 146 for displaying an image, and drivers for driving electrodes within the PDP 146.

The PDP 146 includes an upper substrate and a lower substrate that are placed to be opposite to each other with barrier ribs intervened between them. The upper substrate includes a scan electrode and a sustain electrode formed in the direction in which the upper substrate intersects the barrier ribs. The lower substrate includes an address electrode formed in the direction in which the address electrode is in parallel with the barrier ribs, and a dielectric layer formed to cover the address electrode. A discharge cell is located at a portion where the scan electrode, the sustain electrode and the address electrode intersect.

The drivers includes the scan driving part 152, the sustain driving part 154 and the address driving part 156 for driving the respective electrodes. At this time, the drivers are driven by the timing control signal from the timing controller 144. The scan driving part 152 generates the scan pulses Scan that are sequentially shifted according to the clock signal CLK received from the timing controller 144 and supplies them to scan lines S1 to Sn of the PDP 146. Furthermore, the scan driving part 152 and the sustain driving part 154 supply a sustain pulse for generating a display discharge depending on control of the timing controller 144 to the scan electrodes and the sustain electrodes in the sustain period.

<Second Embodiment>

According to a second embodiment of the present invention, there is provided a method for driving a plasma display panel on which video data is displayed, including: a first step of detecting whether the video data received from an input line exists or not, a second step of generating an APL signal corresponding to a stage of the number of a sustain pulse supplied to the plasma display panel depending on whether the video data exists or not, and a third step of varying a width of a scan pulse supplied to the plasma display panel depending on whether the video data exists or not and also varying the number of the sustain pulse supplied to the plasma display panel in response to the APL signal.

In the method, the first step includes the steps of extracting the video data received from the input line in the 1 horizontal period unit, and determining whether the extracted video data received in the 1 horizontal period unit exists or not to generate a discrimination signal.

In the method, the third step includes varying the period of a reference clock signal for generating the scan pulse in response to the discrimination signal.

The method further includes a fourth step of using the reference clock signal to generate the scan pulse that is sequentially shifted and supplying the scan pulse to the plasma display panel, and a fifth step of supplying the sustain pulse to the plasma display panel.

In the method, the step of generating the discrimination signal includes generating a discrimination signal by determining to which the video data corresponds signal-void video data including pure signal-void video data, video data corresponding to a very dark gray level and video data having a gray level that cannot be seen by a user s naked eyes, or signal-present video data including normal video data.

In the method, the third step includes reducing the period of the reference clock signal for reducing the period of the scan pulse according to the discrimination signal corresponding to the signal-void video data.

In the method, the second step includes generating an APL signal in which the number of the sustain pulse is increased by reducing the stage of the number of the sustain pulse according to the discrimination signal corresponding to the signal-void video data.

In the method, the third step includes increasing the sustain time in each horizontal period where the signal-present video data is supplied according to the APL signal whose number of the sustain is increased.

The second embodiment of the present invention will now be described in detail with reference to the accompanying drawings.

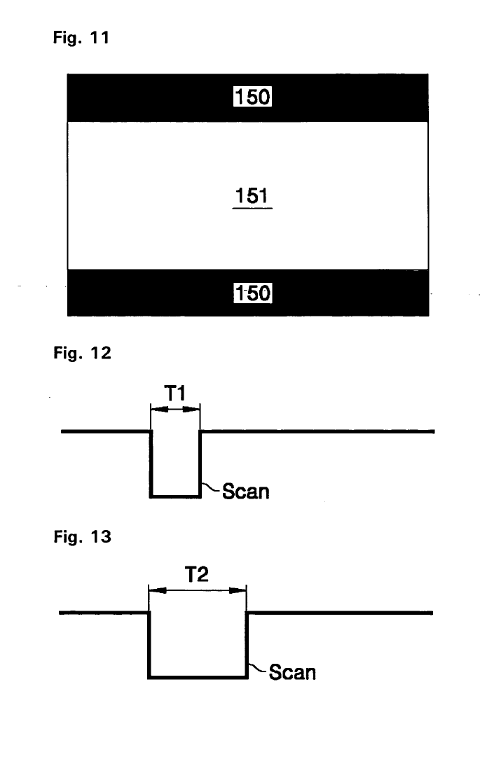

In the method for driving the PDP according to the second embodiment of the present invention, as shown in FIG. 11, in the case where video data is displayed on the PDP 146, video data received from the input line 131 in a 1 horizontal period unit is extracted using the data extraction part by lines 130. It is determined whether the video data of the 1 horizontal period unit extracted using the load discrimination part 158 exists or not. That is, the load discrimination part 158 determines which the extracted video data corresponds to a signal-present video data, a pure signal-void video data, a video data corresponding to a very dark gray level and a gray level that cannot be seen by a user s naked eyes to generate a discrimination signal. Accordingly, the load discrimination part 158 determines that the signal-void video data is supplied to the upper and lower edge regions of the PDP 140 and normal video data is supplied to other region 151, as shown in FIG. 11. Therefore, the load discrimination part 158 generates a discrimination signal in a horizontal line unit of the PDP 146 and supplies the generated discrimination signal to the APL calculation part 142 and the timing controller 144.

Then, the APL calculation part 142 generates an APL stage signal for varying the number of a sustain pulse based on the generated discrimination signal. Furthermore, the timing controller 144 varies the periods T1 and T2 (FIG. 10) of a clock signal CLK for generating a scan pulse Scan based on the generated discrimination signal and supplies the clock signal to the scan driving part 152. At this time, the timing controller 144 reduces the period of the clock signal CLK so that a pulse width T1 of the scan pulse Scan supplied to the scan lines corresponding to the upper and lower edge regions 150 of the PDP 146 is shorter than an normal pulse Width T2. The period of the clock signal CLK is increased so that a pulse width T2 of the scan pulse Scan applied to the scan lines corresponding to other region 151 is the same as the normal pulse width T2.

Accordingly, the scan driving part 152 generates the scan pulse Scan that is sequentially shifted according to the varied clock signal CLK received from the timing controller 144 and supploes the generated scan pulse Scan to the scan lines S1 to Sn of the PDP 146. At the same time, video data is supplied from the address driving part 156 to the address electrode. Due to this, address discharging for selecting a discharge cell is generated in each of the discharge cells of the PDP 146. At this time, the pulse width T1 of the scan pulse Scan that is supplied to each of the scan lines corresponding to the upper and lower edge regions 150 of the PDP 146 has the period T1 shorter than the normal pulse width T2, as shown in FIG. 10 and FIG. 12. The pulse width T2 of the scan pulse Scan that is supplied to each of the scan lines of the other region 151 has the normal period T2, as shown in FIG. 10 and FIG. 13.

Furthermore, the timing controller 144 increases the number of the sustain pulse supplied in the sustain period of the region 151 of the PDP 146 to which the normal video data is supplied by subtracting a value from the time as much as the pulse width T1 of the scan pulse Scan that is reduced according to the discrimination signal in a constant ratio of the APL of the whole frame in response to the APL stage signal received from the APL calculation part 142. That is, the time of an address period that is reduced in the region 150 of the PDP 146 to which pure signal-void video data, video data corresponding to a very dark gray level and video data having a gray level that cannot be seen by a user s naked eyes are supplied to the time of the sustain period in the region 151 of the PDP 146 to which the normal signal-present video data is supplied.

According to the present invention, it is possible to improve the number of a sustain pulse of a sustain period in a region where the normal video data is supplied.

Therefore, according to an apparatus for driving a PDP and method thereof in accordance with embodiments of the present invention, a scan time of lines that are not used, to which pure signal-void video data, video data corresponding to a very dark gray level and video data having a gray level that cannot be seen by a user s naked eyes are supplied is shortened, the reduced scan time is allocated to a sustain time where normal data is supplied, and the number of a sustain pulse applied in a sustain time is increased. Therefore, it is possible to increase brightness.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for driving a plasma display panel, comprising:
a plasma display panel for displaying video data;
a data detection part for detecting whether video data received from an input line exists or not;
an APL calculation part for generating an APL signal corresponding to a stage of the number of a sustain pulse supplied to the plasma display panel depending on whether the video data from the data detection part exists or not; and
a timing controller for varying a width of a scan pulse supplied to the plasma display panel depending on whether the video data from the data detection part exists or not and also varying the number of the sustain pulse supplied to the plasma display panel in response to the APL signal.

2. The apparatus as claimed in claim 1, further comprising:
a data extraction part for extracting the video data received from the input line in the 1 horizontal period unit; and
a load discrimination part for determining whether the video data received in the 1 horizontal period unit from the data extraction part exists or not to generate a discrimination signal.

3. The apparatus as claimed in claim 2, wherein the timing controller varies the period of a reference clock signal for generating the scan pulse in response to the discrimination signal from the load discrimination part.

4. The apparatus as claimed in claim 3, further comprising:
a scan driving part that uses the reference clock signal to generate the scan pulse that is sequentially shifted and supplies the scan pulse to the plasma display panel; and
a sustain driving part that supplies the sustain pulse to the plasma display panel in response to a control signal from the timing controller.

5. The apparatus as claimed in claim 2, wherein the load discrimination part generates a discrimination signal by determining to which the video data received from the data extraction part corresponds signal-void video data including pure signal-void video data, video data corresponding to a very dark gray level and video data having a gray level that cannot be seen by a user s naked eyes, or signal-present video data including normal video data.

6. The apparatus as claimed in claim 5, wherein the timing controller reduces the period of the reference clock signal for reducing the period of the scan pulse according to the discrimination signal corresponding to the signal-void video data from the load discrimination part.

7. The apparatus as claimed in claim 5, wherein the APL calculation part generates an APL signal in which the number of the sustain pulse is increased by reducing the stage of the number of the sustain pulse according to the discrimination signal corresponding to the signal-void video data from the load discrimination part.

8. The apparatus as claimed in claim 7, wherein the timing controller increases the sustain time in each horizontal period where the signal-present video data is supplied according to the APL signal whose number of the sustain pulse from the APL calculation part is increased.

9. A method for driving a plasma display panel on which video data is displayed, comprising:
a first step of detecting whether the video data received from an input line exists or not;
a second step of generating an APL signal corresponding to a stage of the number of a sustain pulse supplied to the plasma display panel depending on whether the video data exists or not; and
a third step of varying a width of a scan pulse supplied to the plasma display panel depending on whether the video data exists or not and also varying the number of the sustain pulse supplied to the plasma display panel in response to the APL signal.

10. The method as claimed in claim 9, wherein the first step comprises the steps of:
extracting the video data received from the input line in the 1 horizontal period unit; and
determining whether the extracted video data received in the 1 horizontal period unit exists or not to generate a discrimination signal.

11. The method as claimed in claim 10, wherein the third step includes varying the period of a reference clock signal for generating the scan pulse in response to the discrimination signal.

12. The method as claimed in claim 11, further comprising:
a fourth step of using the reference clock signal to generate the scan pulse that is sequentially shifted and supplying the scan pulse to the plasma display panel; and
a fifth step of supplying the sustain pulse to the plasma display panel.

13. The method as claimed in claim 10, wherein the step of generating the discrimination signal includes generating a discrimination signal by determining to which the video data corresponds signal-void video data including pure signal-void video data, video data corresponding to a very dark gray level and video data having a gray level that cannot be seen by a user s naked eyes, or signal-present video data including normal video data.

14. The method as claimed in claim 13, wherein the third step includes reducing the period of the reference clock signal for reducing the period of the scan pulse according to the discrimination signal corresponding to the signal-void video data.

15. The method as claimed in claim 13, wherein the second step includes generating an APL signal in which the number of the sustain pulse is increased by reducing the stage of the number of the sustain pulse according to the discrimination signal corresponding to the signal-void video data.

16. The method as claimed in claim 15, wherein the third step includes increasing the sustain time in each horizontal period where the signal-present video data is supplied according to the APL signal whose number of the sustain is increased.
